(19) United States
(12) Patent Application Publication
(10) Pub. No.: US 2025/0029298 A1
(43) Pub. Date: Jan. 23, 2025

(54) IMAGE CREATION AND ROYALTY DISTRIBUTION METHOD

(71) Applicant: Michael Reuben Flax, Toronto (CA)

(72) Inventor: Michael Reuben Flax, Toronto (CA)

(21) Appl. No.: 18/354,938

(22) Filed: Jul. 19, 2023

(51) Int. Cl. G06T 11/60; G06F 21/10; G06F 21/16; G06T 7/50; G06T 7/90

(52) U.S. Cl. CPC G06T 11/60; G06F 21/108; G06F 21/16; G06T 7/50; G06T 7/90

(57) ABSTRACT

An image creation and royalty distribution method that is configured to utilize original artwork captured in digital format wherein the pixels thereof are employed to create new visual artwork. Furthermore, the software of the present invention provides tagging of each of the pixels of the original artwork so as to establish and maintain a record of identity of the creator of each pixel of the original artwork. The software of the present invention creates new visual artwork and subsequent creation thereof will produce a list of creators of original artworks from which pixels were utilized to create the new visual artwork. The method of the present invention facilitates payment to each of the creators of the original artwork from which pixels were utilized in a newly created visual artwork. The tags associated with each pixel of the original artwork are non-fungible tokens, alternative blockchain systems or non-blockchain alternatives.

### FIELD OF THE INVENTION

The present invention relates generally to visual art creation, more specifically but not by way of limitation, a method that provides tagging of original works of art at the pixel level wherein the tagged pixels are tracked during utilization during creation of new works of art in order to enable attribution to the creator of the original work of art.

### BACKGROUND

A blockchain is a distributed ledger with growing lists of records, referred to as blocks, that are securely linked together via cryptographic hashes. Wherein the cryptographic hash will typically contain a cryptographic hash of the previous block, a timestamp, and transaction data regarding the instant transaction. Since each block contains information about the previous block, the blocks form a chain similar to a chain of custody wherein all information preceding the instant transaction is captured and recorded. Consequently, blockchain transactions are irreversible in that, once they are recorded, the data in any given block cannot be altered retroactively without altering all subsequent blocks. This technology provides secure un-editable transactions.

Blockchains are typically managed by a peer-to-peer computer network for use as a public distributed ledger, where nodes collectively adhere to a consensus algorithm protocol to add and validate new transaction blocks. Blockchain technology can be employed in various industries and has been useful for contract creation and management as one example. In the field of visual art generation, there is an issue with potential copyright infringement of an artist's work. Commercially available software is employed for graphic and art design wherein the software utilizes original artwork and subsequently may employ pixels of the original artwork during creation of a new work of visual art. Current technology lacks the ability to properly tag the pixels of the original art works and as such the artists may lose compensation and the creator of the new visual art may be liable for copyright infringement

Accordingly, there is a need for a method that provides an ability to label all of the pixels of an original work of art so as to provide tracking as to when these pixels are utilized to create a new work of visual art and wherein the present invention can employ blockchain or non-blockchain technology.

### SUMMARY OF THE INVENTION

It is the object of the present invention to provide a method that provides tagging of artwork at a pixel level for attribution to an original creator wherein the method present invention compiles a plurality of original artworks.

Another object of the present invention is to provide a method of providing attribution to a creator of an original work of art wherein the present invention employs non-fungible token assignment to each pixel of an original work of art.

A further object of the present invention is to provide a method that provides tagging of artwork at a pixel level for attribution to an original creator wherein the method further includes utilization of a plurality of original artworks in an artificial intelligence based software for creation of new visual artworks.

Yet a further object of the present invention is to provide a method of providing attribution to a creator of an original work of art wherein the present invention provides determination of the percentage of the new artwork that is formed from utilization of a portion of an original artwork.

Still another object of the present invention is to provide a method that provides tagging of artwork at a pixel level for attribution to an original creator wherein the method of the present invention can employ evaluation of parameters such as but not limited to shapes, colors and composition in determining original artwork content level in a new artwork.

An additional object of the present invention is to provide a method of providing attribution to a creator of an original work of art wherein the method of the present invention is operable to distribute a royalty payment for utilization of a portion of an original artwork to the creator thereof.

Yet a further object of the present invention is to provide a method that provides tagging of artwork at a pixel level for attribution to an original creator wherein the method provides tagging of an original artwork with multiple non-fungible tokens comprised in a grid corresponding to the pixels in the artwork.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a flowchart of the process facilitated by the present invention.

### DETAILED DESCRIPTION

Referring now to the drawings submitted herewith, wherein various elements depicted therein are not necessarily drawn to scale and wherein through the views and FIGURES like elements are referenced with identical reference numerals, there is illustrated an image creation and royalty distribution method 100 constructed according to the principles of the present invention.

An embodiment of the present invention is discussed herein with reference to the FIGURES submitted herewith. Those skilled in the art will understand that the detailed description herein with respect to these FIGURES is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

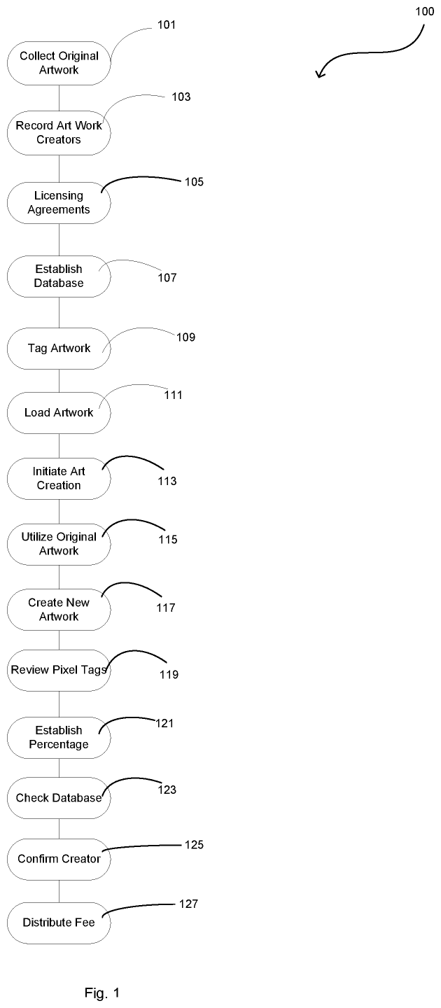

Referring in particular to the FIGURES submitted herewith, the image creation and royalty distribution method 100 is outlined in a flowchart in FIG. 1. In step 101 of the image creation and royalty distribution method 100 the operator of the software facilitating the present invention collects a multitude of original artworks. It should be understood within the scope of the present invention that the artworks are either digital or captured digitally for subsequent use thereof. The digital artwork files can either be a single frame or a video file. Step 103, the original creators of each of the original works of art are recorded. In step 105, the operator of the image creation and royalty distribution method 100 establishes licensing agreements that are executed between the creators of the original artworks and the operator of the image creation and royalty distribution method 100. Step 107, a database of the licensing agreements containing all data parameters associated with each of the licensing agreements to include parameters such as but not limited to creator information and licensing fees is established and maintained by the operator on a suitable computing device.

In step 109, the operator of the image creation and royalty distribution method 100 tags each of the collected original artworks. It should be understood within the scope of the present invention that each original artwork is assigned a multitude of non-fungible tokens at the pixel level in the digital version of the original artwork. In a preferred embodiment, the non-fungible tokens are assigned within a created grid that corresponds to the pixels in the digital version of the original artwork. Each created grid includes multiple layers which include but are not limited to grey scale to identify shapes, color to identify style and vibrancy and a layer to identify composition. Each section of each layer of the created grid is assigned a non-fungible token that provides identification of the original artwork creator. In step 111, digital versions of the original artwork are loaded into the software employed by the present invention. It should be understood within the scope of the present invention that the software employed by the present invention is a generative artificial intelligence visual media platform that is operable to generate new visual artwork.

Step 113, the software will initiate creation of a new visual artwork. Step 115, during creation of the new visual artwork, the software utilized in the present invention will utilize pixels from the original artwork loaded into the database of original artwork within the software. It should be understood within the scope of the present invention that the creation of the new visual artwork could utilize as few as one pixel or a multitude of pixels from either a single or multitude of original artworks stored in the database. In step 117, the software of the present invention completes creation of a new visual artwork. Step 119, ensuing completion of the new visual artwork the software of the present invention is utilized to review all of the pixels of the newly created artwork so as to identify the non-fungible tokens associated with each pixel of the newly created visual artwork. Step 121, the pixels in the newly created visual artwork are categorized by their non-fungible tokens wherein the categorization is completed so as to identify the creator of the content of the pixel. Each associated pixel having the same creator is then assigned a percentage of the amount of the newly created visual artwork that contains pixels with the original content of the creator of the original work of art. This process is executed for each of the creators from which pixels were employed in the creation of the new visual artwork.

In step 123, the software provides a list of creators from which content of their original artwork was utilized to create the new visual artwork and reviews the licensing agreements for each creator that is stored in the database. Step 125, the creator for the utilized pixels in the new visual artwork is confirmed wherein the parameters of the licensing fees is confirmed. In step 127, the operator of the image creation and royalty distribution method 100 will distribute the licensing fee to the creators of the original artwork wherein pixels thereof were employed in the creation of the new visual artwork in compliance with the terms of the licensing agreement. In a preferred embodiment of the present invention the licensing fee distributed to the creators is correlated to the amount of the creators pixel utilized as a percentage of the entire new visual artwork.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An image creation and royalty distribution method comprising the steps of:
collecting a multitude of original artworks, wherein the multitude of original artworks are collected in a digital format;
recording creator identification for each of the multitude of original artworks, wherein the creator identification is stored in a database;
tagging each of the multitude of original artworks, wherein each of the multitude of original artworks is tagged at a pixel level wherein each pixel is tagged with a non-fungible token containing data parameters on the original artwork creator;
loading the multitude of artwork in a software, wherein the software is a visual generation software operable to create new visual works of art;
initiating generation of new visual works of art, wherein the software commences making new visual works of art, wherein the new visual works of art are comprised from pixels of the multitude of original artworks;
completing a new visual work of art, wherein the software completes creation of a new visual work of art;
reviewing the tags for each pixel of the new visual work of art;
acknowledging the creator identification for each pixel utilized in the new visual work of art;
reviewing the database for the creator identification of the multitude of original artworks;
confirming the creators of the pixels of the new visual work of art wherein the pixels of the new visual work of art are pixels from the multitude of original artwork;
determining a licensing fee to be paid to the creators of the original artwork;
paying a fee to the creators of the original artwork.

2. The image creation and royalty distribution method as recited in claim 1, wherein the fee paid to the creators of the original artwork is correlated to the percentage of pixels utilized by the software that comprise the new visual work of art.

3. The image creation and royalty distribution method as recited in claim 2, and further including the step of establishing a grid corresponding to the pixel layout in the original artwork.

4. The image creation and royalty distribution method as recited in claim 3, wherein the grid includes a plurality of layers.

5. The image creation and royalty distribution method as recited in claim 4, wherein the layers of the grid consist of: grey scale to identify shapes, color to identify style and vibrancy and a layer for composition.

6. The image creation and royalty distribution method as recited in claim 5, and further including the step of establishing licensing agreements, wherein the creators of the original artworks execute a licensing agreement with an operator of the image creation and royalty distribution method.

7. The image creation and royalty distribution method as recited in claim 6, wherein the visual artwork generation software employs artificial intelligence.
